(19) United States
(12) Patent Application Publication
(10) Pub. No.: US 2012/0229856 A1
(43) Pub. Date: Sep. 13, 2012

(54) IMAGE FORMING APPARATUS, METHOD OF CONTROLLING START, AND START CONTROL PROGRAM

(75) Inventor: Masaki Karakawa, Kanagawa (JP)

(73) Assignee: RICOH COMPANY, LIMITED, Tokyo (JP)

(21) Appl. No.: 13/409,320

(22) Filed: Mar. 1, 2012

(30) Foreign Application Priority Data
Mar. 11, 2011 (JP) 2011-054704

(51) Int. Cl. G06K 15/02

(52) U.S. Cl. 358/1.16

(57) ABSTRACT

According to an embodiment, an image forming apparatus includes: a memory unit that stores therein apparatus information on each function to be executed; and a control unit that reads the apparatus information stored in the memory unit to execute given control based on the apparatus information that is read; the image forming apparatus forming an image on a recording medium. The apparatus information is written sequentially and collectively for each function in the memory unit.

### CROSS-REFERENCE TO RELATED APPLICATIONS

The present application claims priority to and incorporates by reference the entire contents of Japanese Patent Application No. 2011-054704 filed in Japan on Mar. 11, 2011.

### BACKGROUND OF THE INVENTION

1. Field of the Invention

Embodiments described relate to an image forming apparatus, a method of controlling a start, and a start control program, and more particularly relate to a technology for starting up a priority function in starting an engine control section in an image forming apparatus such as a printer, a copying machine, a facsimile, or a digital MFP.

2. Description of the Related Art

In recent years, there is an increasing tendency to digitize information and image forming apparatuses such as printers and facsimiles that are used for outputting digitized information, and scanners that are used for digitizing documents have become essential equipment. The image forming apparatuses often have functions of capturing an image, forming an image, communication and the like to be constituted as an MFP capable of functioning as a printer, a facsimile, a scanner, and a copying machine. In this type of image forming apparatus, it is desired to shorten the time from when a user starts supplying power to the apparatus to when the apparatus is ready to use, that is, a shorter starting time is desired. In start processing for the image forming apparatus, various processes are conducted, including checking each unit of the apparatus and preparation for use.

There is a technique to shorten the starting time by reading apparatus information stored in a non-volatile memory device, such as a parameter, that individually controls an entire module before start processing for a certain function is conducted. One of those techniques is disclosed, for example, in Japanese Patent Application Laid-open No. 2008-233407 and already known, in which after reading all apparatus information, start processing for a function desired to be preferentially operated (fixing, for example) is preferentially conducted.

In this technique, the time period from when power is supplied to an apparatus to when heating a fixing unit is started is reduced and thereby the starting time of the image forming apparatus is shortened. The apparatus has a fixing section that fixes a developer image transferred on a sheet; and a control section that controls each section included in the image forming apparatus and checks a start. The control section preferentially checks a part associated with fixing section operation rather than the other parts among the sections included in the image forming apparatus and starts the fixing section when checking the part associated with the fixing unit operation is finished. At the time, when an engine control section is started, only after all the apparatus information data, such as parameters, that controls each section is acquired from a non-volatile memory device, such as a ROM and an EEPROM, included in the engine control section, start processing for the fixing section is preferentially conducted.

In the invention of Japanese Patent Application Laid-open No. 2008-233407 described above, when the engine control section is started, all the apparatus information data, such as parameters, that controls each section is acquired from a non-volatile memory device, such as a ROM and an EEPROM, included in the engine control section. However, the apparatus information also includes information necessary for starting a plurality of functions and each module is described by the apparatus information. Accordingly, while apparatus information data other than information necessary for starting a given function, a fixing for example, is being acquired, that is, until reading all the apparatus information is finished, it is impossible to conduct start processing for the given function.

Accordingly, there is a need to allow start processing for a desired function on a higher priority to be conducted without waiting for all the apparatus information to be read, thereby reducing the time before the desired function is started in use.

### SUMMARY OF THE INVENTION

It is an object of the present invention to at least partially solve the problems in the conventional technology.

According to an embodiment, an image forming apparatus includes: a memory unit that stores therein apparatus information on each function to be executed; and a control unit that reads the apparatus information stored in the memory unit to execute given control based on the apparatus information that is read; the image forming apparatus forming an image on a recording medium. The apparatus information is written sequentially and collectively for each function in the memory unit.

According to another embodiment, a method of controlling a start of an image forming apparatus is provided. The image forming apparatus forms an image on a recording medium and that includes a memory unit that stores therein apparatus information on each function to be executed; and a control unit that reads the apparatus information stored in the memory unit to execute given control based on the apparatus information that is read. The method includes: reading the apparatus information written at top of the memory region when starting the apparatus, wherein the apparatus information with a highest priority function at the starting the apparatus is collectively written at the top of a memory region in the memory unit; and starting a start processing for a function corresponding to the apparatus information with the highest priority function, after having read the apparatus information written at the top of the memory region at the reading.

According to still another embodiment, a computer program product includes a non-transitory computer-usable medium having computer-readable program codes embodied in the medium for an image forming apparatus. The image forming apparatus forms an image on a recording medium. The program codes, when executed, causes a computer to execute: reading the apparatus information written at top of the memory region when starting the apparatus, wherein the apparatus information with a highest priority function at the starting the apparatus is collectively written at the top of a memory region in the memory unit; and starting a start processing for a function corresponding to the apparatus information with the highest priority function, after having read the apparatus information written at the top of the memory region at the reading.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating an entire image forming apparatus in accordance with an embodiment;

FIG. 2 is a functional block diagram illustrating a control structure of the image forming apparatus in accordance with the embodiment;

FIG. 3 is a view for describing a sequence of apparatus information to be read when starting an engine control unit, the information being stored in a non-volatile memory device; and

FIG. 4 is a view for describing start processing to preferentially operate a fixing unit.

### DETAILED DESCRIPTION OF THE PREFERRED EMBODIMENTS

In the embodiment, when an engine control unit is started, apparatus information data, such as parameters, that control each unit are collectively written for each type of information necessary for starting a given function (for example, a fixing) in a non-volatile memory device, such as a ROM and an EEPROM, that is included in the engine control unit and, directly after the information necessary for executing a desired function is acquired and even before all the apparatus information is acquired, start processing for the desired function is executed.

Hereinafter, embodiments will be described in detail with reference to the drawings.

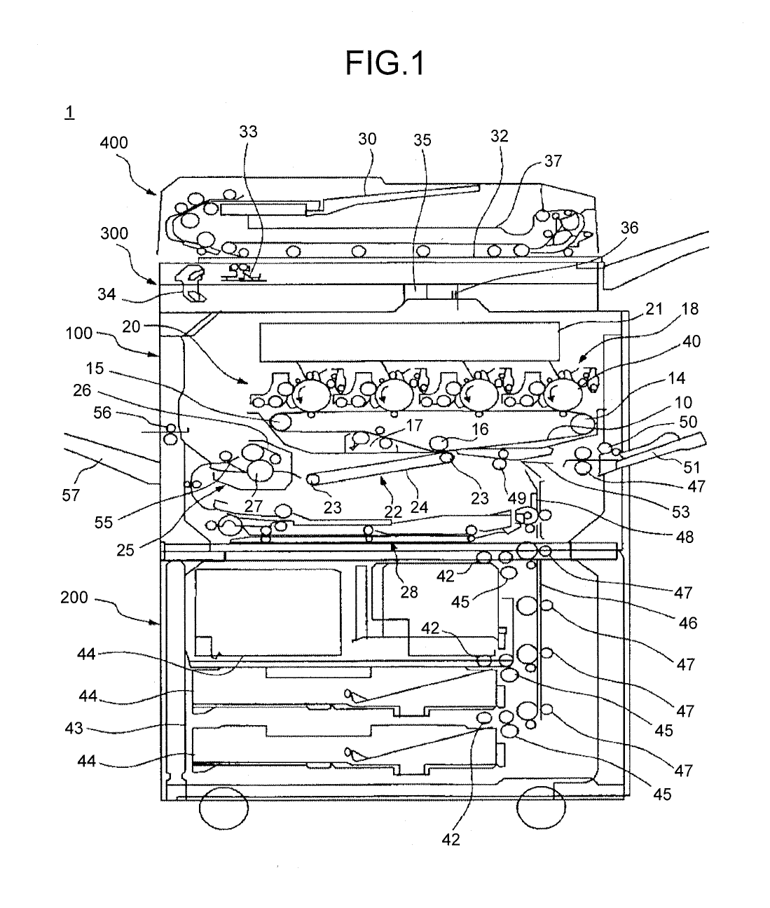

FIG. 1 is a schematic diagram illustrating the entire image forming apparatus in accordance with the present embodiment. As illustrated in the drawing, an image forming apparatus 1 in accordance with the present embodiment has a printer engine 100, a paper feeding table 200, a scanner unit 300, and an auto document feeder (ADF) 400. The printer engine 100 has an intermediate transfer unit in the center and the intermediate transfer unit has an intermediate transfer belt 10 serving as an endless belt.

The intermediate transfer belt 10 is extended by three supporting rollers 14 to 16 and driven to rotate clockwise. An intermediate transfer body cleaning unit 17 is provided in the left of the second supporting roller 15, removing residual toner left behind on the intermediate transfer belt 10 after transferring an image. An image forming device 20 is provided opposed to a belt surface of the intermediate transfer belt 10 between the first supporting roller 14 and the second supporting roller 15. The image forming device 20 includes image forming units 18 each for black (K), yellow (Y), magenta (M), and cyan (C) along a moving direction of the intermediate transfer belt 10. The image forming unit 18 has a photosensitive element 40, a tonner (developer) bottle, a charging unit, a developing unit and a photosensitive-element cleaning unit (not illustrated) for each color. The photosensitive element cleaning unit has a photosensitive-element waste tonner bottle that temporarily stores therein tonner peeled off from the photosensitive element 40. Above the image forming device 20, a writing unit 21 that irradiates each photosensitive element of the photosensitive-element unit for each color with laser light to form an image is provided.

Below the intermediate transfer belt 10, a secondary transfer unit 22 is provided. In the secondary transfer unit 22, a secondary transfer belt 24 serving as an endless belt is extended between two rollers 23 and arranged to push up the intermediate transfer belt 10 to press against the third supporting roller 16. The secondary transfer belt 24 transfers an image on the intermediate transfer belt 10 to a sheet. Next to the secondary transfer unit 22, a fixing unit 25 is provided to fix the image having transferred to the sheet, where a sheet having a tonner image (developer image) transferred thereon is fed. In the fixing unit 25, a fixing belt 26 serving as an endless belt is pressed against a fixing roller 27. In addition to that, a heater (heating unit) for the fixing roller 27 is also included. Below the secondary transfer unit 22 and the fixing unit 25, a sheet reverse unit 28 is provided. The sheet reverse unit 28 turns over and feeds the sheet to record an image on a reverse side of the sheet immediately after forming the image on a top side.

In an operation unit (not illustrated in FIG. 1) of the image forming apparatus 1, when a start switch is pressed and if an original is placed on a platen 30 of the ADF 400, the original is conveyed onto an exposure glass 32. If an original is not placed in the ADF 400, in order to read an original placed on the exposure glass 32 by hand, the scanner unit 300 drives a scanner, driving a first carriage 33 and a second carriage 34 to scan. When a light source on the first carriage 33 projects light to the exposure glass, the light reflected by an original surface is reflected by a first mirror on the first carriage 33 to the second carriage 34, then reflected by a mirror on the second carriage 34, going through an imaging lens 35 to form an image on a charge coupled devices (CCD) 36 serving as a scanning sensor. Based on image signals obtained by the CCD 36, recording data for each color K, Y, M and C are created.

Additionally, when the start switch is pressed, the intermediate transfer belt 10 is started to be driven to rotate and each unit included in the image forming unit 20 is started to prepare for image formation. Once a sequence of image formation in each color is started, an exposure laser modulated based on the recording data for each color is projected over the photosensitive element for each color. By image formation processes for each color, tonner images in each color are transferred and overlapped as a piece of image on the intermediate transfer belt 10. A sheet is timely fed to the secondary transfer unit 22 such that a top end of the sheet for image formation enters the secondary transfer unit 22 at the same time when a top end of the tonner image formed on the intermediate transfer belt 10 overlaps with the secondary transfer unit 22. The tonner image on the intermediate transfer belt 10 is thereby transferred onto the sheet. The sheet having the tonner image transferred thereon is fed to the fixing unit 25 and the tonner image is fixed on the sheet through heating and pressing processing by the fixing unit 25. Here, a mechanism with two transfer belts, the intermediate transfer belt and the secondary transfer belt, is explained, but a transfer mechanism with one belt is also possible.

With respect to the sheet for image formation, when one of paper feeding rollers 42 in the paper feeding table 200 is selected to be driven to rotate, the sheet is supplied from one of paper feeding trays 44 provided in the form of a plurality of paper cassettes in a paper feeding unit 43. A separating roller 45 selects a piece of the sheet which is fed to a paper conveying roller unit 46, conveyed by paper conveying rollers 47 to a paper conveying roller unit 48 in the printer engine 100, touched at a registration roller 49 in the paper conveying roller unit 48 and stopped, and then fed to the secondary transfer unit 22 in the above-stated timing. Feeding paper may also be done by placing sheets in a bypass tray 51. When a user places the sheets in the bypass tray 51, the printer engine 100 drives a paper feeding roller 50 to rotate and separates a sheet from the sheets in the bypass tray 51. The sheet is supplied in a bypass path 53 to abut at the registration roller 49 and stop in the same manner.

The sheet that is subjected to fixing processing in the fixing unit 25 and discharged is guided by a switching claw 55 to a discharging roller 56 and stacked on a discharge tray 57. In another mode, a sheet is guided by the switching claw 55 to the sheet reverse unit 28, turned over there and reversed back to a transfer position. After an image is formed on a reverse side, the sheet is conveyed to the discharging roller 56. Residual tonner remaining on the intermediate transfer belt 10 after image transfer is removed by the intermediate transfer body cleaning unit 17 and the intermediate transfer belt 10 is prepared for another image formation. Generally, the registration roller 49 is often used by grounding, so applying bias voltage is also possible to eliminate paper powder on the sheet. In that case, a conductive rubber roller is used, for example, and bias voltage is applied. For the conductive rubber roller, a conductive NBR rubber with a diameter of 18 mm and a surface thickness of 1 mm can be used. Electrical resistivity is approximately 109 Ωcm by volume resistivity of the rubber.

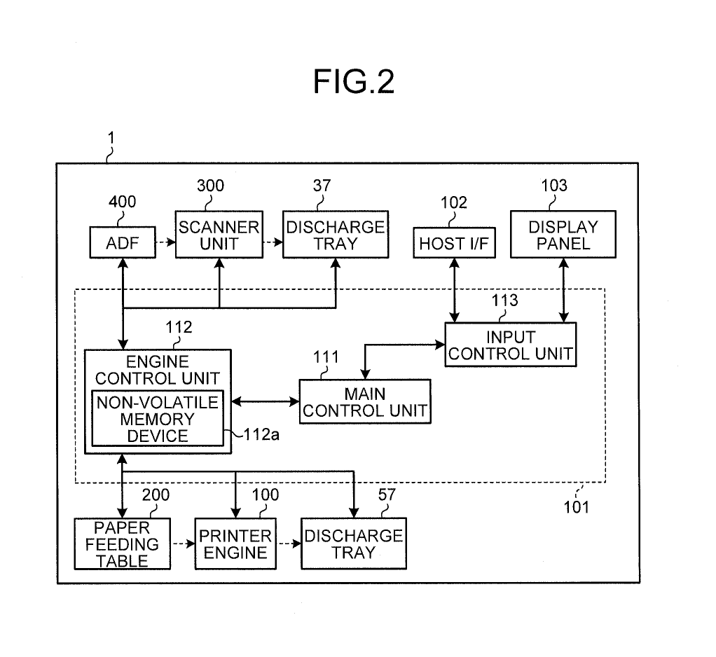

FIG. 2 is a functional block diagram illustrating a control structure of an image forming apparatus in accordance with the present embodiment. In the drawing, a control system of the image forming apparatus 1 in accordance with the present embodiment is constituted centering on a controller 101. The controller 101 has a host I/F 102 and a display panel 103. It should be noted that in FIG. 2, electrical connection is indicated by a solid line arrow and the flow of the sheet is indicated by a broken line arrow.

A host I/F 102 serves as an interface when the image forming apparatus 1 communicates through lines such as a LAN to other devices such as a host apparatus. A print job transmitted from the host apparatus is input through the host I/F 102 in the controller 101 and printing processing is executed under control of the controller 101. The display panel 103 serves as an output interface that visually displays a state of the image forming apparatus 1, and also serves as an input interface that a user can use as a touch panel to directly operate the image forming apparatus 1.

Software and hardware are combined to constitute the controller 101. Specifically, the controller 101 is constituted by a software control unit where control programs such as firmware stored in a non-volatile memory medium (device), such as a read only memory (ROM), an electronically erasable and programmable ROM (EEPROM), a magnetic disk, and an optical disk, are loaded to a volatile memory, such as a dynamic random access memory (DRAM), under control of a central processing unit (CPU); and by hardware such as an integrated circuit. The controller 101 includes a main control unit 111, an engine control unit 112, and an input control unit 113 for respective functions.

The main control unit 111 is in charge of controlling respective control units included in the controller 101 as a whole and gives instructions to each unit in the controller 101 based on signals received or created by other control units. The engine control unit 112 serves as a driving unit that controls or drives an image forming unit, such as the printer engine 100 and the paper feeding table 200; and an image capturing unit, such as the scanner unit 300 and the ADF 400. In accordance with the instruction from the main control unit 111, the engine control unit 112 drives the paper feeding roller 42 and the paper conveying roller 47 included in the paper feeding table 200 to convey a sheet to the printer engine 100 and also drives the printer engine 100 to execute image formation on the sheet. Additionally, in accordance with the instruction from the main control unit 111, the engine control unit 112 drives the platen 30 and the conveying roller included in the ADF 400 to convey an original onto the exposure glass 32 and also drives the first carriage 33 and the second carriage 34 to convert optical information on the original scanned by the CCD 36 into electrical signals.

Furthermore, once power is supplied to the image forming apparatus 1 to constitute the controller 101, without being controlled by the main control unit 111, the engine control unit 112 independently executes start processing for the printer engine 100, the scanner unit 300, the ADF 400, and the like. The input control unit 113 inputs a print job that is input through the host I/F 102; and operation information that a user inputs with the display panel 103; into the main control unit 111. The input control unit 113 also, in accordance with instructions from the main control unit 111, displays information on the display panel 103 or transmits information through the host I/F 102 to the host apparatus.

In general, the image forming apparatus 1 constituted as described above usually operates as below. When the image forming apparatus 1 operates as a printer, the input control unit 113 inputs a print job that has been received through a universal serial bus (USB) or a local area network (LAN) connected to the host I/F 102 into the main control unit 111. The main control unit 111 inputs the received print job into the engine control unit 112. The engine control unit 112 controls the printer engine 100 and the paper feeding table 200 to pull out a printing sheet from the paper feeding table 200 and convey it to the printer engine 100, and to create printing information from image information included in the print job to input it into the printer engine 100. The printer engine 100 executes image formation in accordance with the printing information input from the engine control unit 112 on the sheet conveyed from the paper feeding table 200. Furthermore, the printer engine 100 discharges the sheet finished with the image formation to the discharge tray 57.

When the image forming apparatus 1 operates as a scanner, in response to a user's operation with the display panel 103, the input control unit 113 transmits operation signals to the main control unit 111. The main control unit 111 inputs the operation signals received from the input control unit 113 into the engine control unit 112. The engine control unit 112 controls the scanner unit 300 and the ADF 400 to convey an original targeted for image capturing placed in the ADF 400 to the scanner unit 300, optically scan the original with image capturing elements such as CCDs included in the scanner unit 300, and create image information from optical information. The engine control unit 112 receives the image information created by the scanner unit 300. The engine control unit 112 creates printing information based on the image information received from the scanner unit 300 and drives, based on the printing information, the printer engine 100 and the paper feeding table 200 in the same manner as the printer operation.

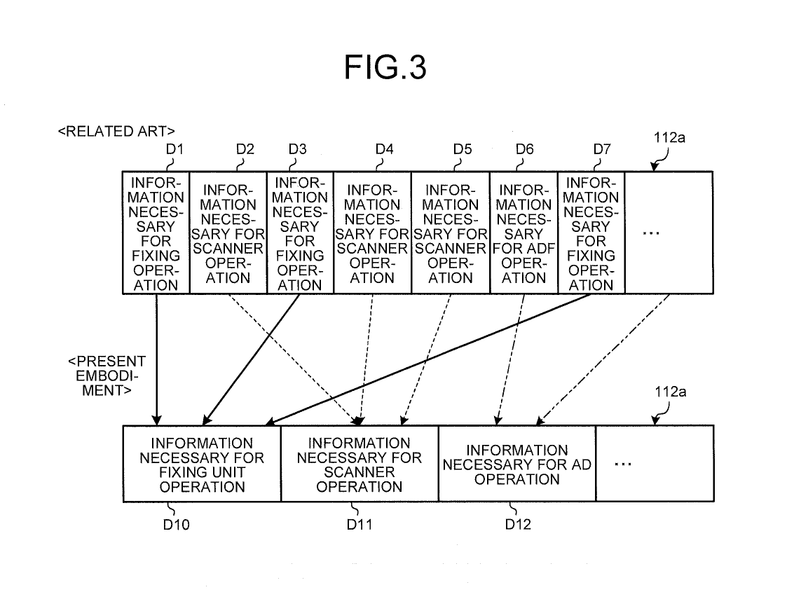

FIG. 3 is a view for describing a sequence of apparatus information on each unit of the engine unit stored in a non-volatile memory device 112a that the engine control unit reads at the time of start. D represents the apparatus information stored in the non-volatile memory device 112a, such as a ROM and an EEPROM, included in the engine control unit 112. In a related art as illustrated in FIG. 3, the non-volatile memory device 112a randomly stores therein information D1, D3, and D7 that are necessary for fixing operation; information D2, D4, and D5 that are necessary for scanner operation; and information D6 that is necessary for ADF operation. Therefore, even when the fixing unit 25 is desired to be preferentially operated, start processing cannot be executed before reading all the apparatus information is finished.

In the present embodiment, as illustrated in FIG. 3, information on various functions of the engine unit (reading, writing, developing, transferring, fixing, feeding and discharging a sheet, and the like) is collectively written in the non-volatile memory device 112a in advance and the engine control unit 112 reads the information by function. At this time, a reading priority at the time of start is also written in the non-volatile memory device 112a and reading is conducted in accordance with the reading priority. Alternatively, apparatus information is written in accordance with a priority sequentially from the top of a memory region in advance and reading is conducted from the top.

For example, in the example of FIG. 3, the information D1, D3, and D7 that are necessary for fixing operation; the information D2, D4, and D5 that are necessary for scanner operation; and the information D6 that is necessary for ADF operation are written collectively from the top of the non-volatile memory device 112a as information D10 necessary for fixing operation; information D11 necessary for scanner operation; and information D12 necessary for ADF operation. When power of the image forming apparatus 1 is turned on to start the image forming apparatus 1, the engine control unit 112 starts reading the memory region of the non-volatile memory device 112a that stores therein the apparatus information on start processing, from the top in the order of D10, D11, D12 . . . . During this operation, when reading the apparatus information D10 is completed, start processing for the fixing unit 25 is started based on the read apparatus information. During this operation, the information D11 necessary for scanner operation, the information D12 necessary for ADF operation, and the like are individually read in parallel.

In this way, apparatus information necessary for operation is organized as information D10. Reading is started with the information D10 and when the reading is completed, the engine control unit 112 can start the start processing for the fixing unit 25. Here, description is given on a preferential start of the fixing unit 25, but when information to execute a function desired to be preferentially started is preferentially written from the top in the non-volatile memory device 112a, any function can be preferentially started in the same manner. At this time, the information D10 necessary for fixing operation, the information D11 necessary for scanner operation, and the information D12 necessary for ADF operation are distinguished software-wise and what kind of function is stored in which region can be recognized by the engine control unit 112.

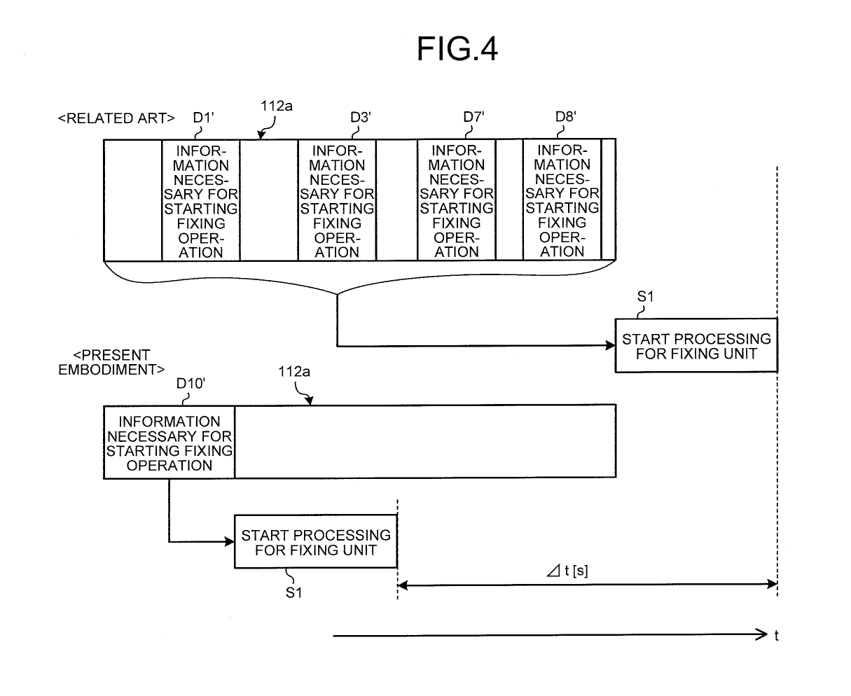

FIG. 4 is a view for describing start processing to preferentially operate a certain function, a fixing unit in this example. As illustrated in FIG. 4, in the related art, apparatus information D1′, D3′, D7′, and D8′ that are to be read when starting the engine control unit are separately recorded and stored as apparatus information in the non-volatile memory device 112a without being associated with the functions as information D1, D3, and D7 that are necessary for fixing operation. In the related art, because the engine control unit 112 reads the information D1, D3, and D7 that are necessary for fixing operation sequentially from the top, start processing S1 for the fixing unit is executed after reading all the apparatus information is finished based on the information necessary for start processing for the fixing unit 25 among them.

In contrast, in the present embodiment, as illustrated in FIG. 4, when the engine control unit is started, the engine control unit reads the information D10′ created by organizing the information D1′, D3′, D7′, and D8′ that are necessary for starting the fixing unit 25 together. Therefore, even before reading all the apparatus information including other functions is finished, when reading the information D10′ necessary for starting the fixing unit 25 is finished, start processing S1 for the fixing unit 25 can be started. As a result, compared with the related art, the starting time can be reduced by Δt. It should be noted that whether to read the other apparatus information and whether to execute the other processing in parallel with start processing for the fixing unit 25 are optional.

As described above, according to the present embodiment, apparatus information data that controls each unit, such as parameters, is collectively written for each type of information necessary for starting a desired function in a non-volatile memory apparatus, such as a ROM or an EEPROM that is included in the engine control unit. When the image forming apparatus 1 is started, the engine control unit 112 can conduct start processing for the desired function, without acquiring all the apparatus information, directly after acquiring the apparatus information necessary for executing the desired function to preferentially start it. As a result, it is possible to shorten a time before starting the desired function and thereby speed up start of the image forming apparatus.

According to the embodiment, when high priority apparatus information has been read, start processing for the apparatus corresponding to the high priority apparatus information can be started. As a result, it is possible to reduce the time period before starting the high priority function in use.

It should be noted that in embodiments described above, apparatus information corresponds to information D1 to D8, and D10 to D12; a control unit corresponds to an engine control unit 112; a recording medium corresponds to a sheet; an image forming apparatus corresponds to a numeral 1; a memory unit corresponds to a non-volatile memory device 112a; an engine unit corresponds to a paper feeding table 200, a printer engine 100, a discharge tray 57, an ADF 400, a scanner unit 300, a discharge tray 37, and an engine control unit 112; and a fixing unit corresponds to a numeral 25.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a memory unit that stores therein apparatus information on each function to be executed; and
a control unit that reads the apparatus information stored in the memory unit to execute given control based on the apparatus information that is read; the image forming apparatus forming an image on a recording medium, wherein
the apparatus information is written sequentially and collectively for each function in the memory unit.

2. The image forming apparatus according to claim 1, wherein
the memory unit stores the apparatus information on whether the function is preferentially started for each function; and
the control unit determines whether the function be preferentially started based on the read apparatus information, and executes start processing based on the determination.

3. The image forming apparatus according to claim 2, wherein
when there are a plurality of functions to be preferentially started, the memory unit stores therein a priority to start the functions.

4. The image forming apparatus according to claim 3, wherein
apparatus information necessary for starting function with a highest priority is written at top of a memory region that is to be read at a starting in the memory unit.

5. The image forming apparatus according to claim 3, wherein
apparatus information necessary for starting a function is written sequentially in a priority order from top of a memory region that is to be read at a starting in the memory unit.

6. The image forming apparatus according to claim 2, wherein
the start processing is a start processing for an engine control unit that controls an engine unit in the image forming apparatus.

7. The image forming apparatus according to claim 6, wherein
the start processing is start processing for a fixing unit of the engine unit.

8. The image forming apparatus according to claim 1, wherein
the memory unit is of a non-volatile memory device.

9. A method of controlling a start of an image forming apparatus that forms an image on a recording medium and that includes
a memory unit that stores therein apparatus information on each function to be executed; and
a control unit that reads the apparatus information stored in the memory unit to execute given control based on the apparatus information that is read,
the method comprising:
reading the apparatus information written at top of the memory region when starting the apparatus, wherein
the apparatus information with a highest priority function at the starting the apparatus is collectively written at the top of a memory region in the memory unit; and
starting a start processing for a function corresponding to the apparatus information with the highest priority function, after having read the apparatus information written at the top of the memory region at the reading.

10. A computer program product comprising a non-transitory computer-usable medium having computer-readable program codes embodied in the medium for an image forming apparatus that forms an image on a recording medium, the program codes, when executed, causing a computer to execute:
reading the apparatus information written at top of the memory region when starting the apparatus, wherein
the apparatus information with a highest priority function at the starting the apparatus is collectively written at the top of a memory region in the memory unit; and
starting a start processing for a function corresponding to the apparatus information with the highest priority function, after having read the apparatus information written at the top of the memory region at the reading.
